(19) United States
(12) Patent Application Publication
(10) Pub. No.: US 2025/0309720 A1
(43) Pub. Date: Oct. 2, 2025

(54) STATOR, MOTOR, COMPRESSOR, REFRIGERATION CYCLE APPARATUS, AND STATOR MANUFACTURING METHOD

(71) Applicant: Mitsubishi Electric Corporation, Tokyo (JP)

(72) Inventor: Masashi ONO, Tokyo (JP)

(21) Appl. No.: 18/862,318

(22) PCT Filed: Jul. 4, 2022
(86) PCT No.: PCT/JP2022/026587

§ 371 Date: Nov. 1, 2024

(51) Int. Cl. H02K 3/34; F25B 31/02; H02K 3/02; H02K 3/12; H02K 3/30; H02K 15/10

(52) U.S. Cl. CPC H02K 3/34; F25B 31/026; H02K 3/02; H02K 3/12; H02K 3/30; H02K 15/10

(57) ABSTRACT

A stator includes a hollow cylindrical stator core, a first coated wire including a first wire conductor and an insulating coating covering the first wire conductor, and a second coated wire including a second wire conductor and an insulating coating covering the second wire conductor, the first and second wire conductors having different hardnesses, the first wire conductor being harder than the second wire conductor, the insulating coating covering the second wire conductor being thicker than the insulating coating covering the first wire conductor. The first coated wire and the second coated wire are wound together around teeth arranged in a circumferential direction of the stator core. Such a configuration inhibits a short-circuit in and/or burning of coils.

### CROSS-REFERENCE TO RELATED APPLICATION

This application is a U.S. national stage application of PCT/JP2022/026587 filed on Jul. 4, 2022, the contents of which are incorporated herein by reference.

### TECHNICAL FIELD

The present disclosure relates to a stator, a motor, a compressor, a refrigeration cycle apparatus, and a stator manufacturing method.

### BACKGROUND

A typical motor includes a hollow cylindrical stator core and coils formed by coated wires wound around teeth arranged in a circumferential direction of the stator core. Examples of the coated wires include a copper wire including a copper wire conductor and an insulating coating covering the copper wire conductor and an aluminum wire including an aluminum wire conductor and an insulating coating covering the aluminum wire conductor.

For example, Patent Literature 1 describes coils formed by a copper wire and an aluminum wire wound separately around teeth in a concentrated winding manner. In such a case, a gripper of a winding machine does not need to simultaneously grip both the copper wire and the aluminum wire, or two wires.

### PATENT LITERATURE

Patent Literature 1: International Publication No. WO 2014/188466

To wind the copper wire and the aluminum wire together around the teeth to form coils, both the copper wire and the aluminum wire, or two wires, are simultaneously gripped by the gripper of the winding machine. In general, the copper wire conductor and the aluminum wire conductor are equalized in wire diameter and the insulating coatings covering the respective wire conductors are equalized in thickness to eliminate a gap between the gripper and the copper and aluminum wires that is caused by the difference in wire diameter between the copper wire and the aluminum wire.

The difference in hardness between the wire conductors, however, causes the wire conductors to be deformed by different amounts upon application of a gripping force of the gripper. This causes the extent of contact between the gripper and one wire to differ from that between the gripper and the other wire. For this reason, the wires are likely to slip from the gripper, which may cause winding irregularities.

When the gripping force of the gripper is increased to prevent winding irregularities, the gripping force of the gripper produces an impression in the aluminum wire conductor, which is softer than the copper wire conductor. A cross-section of the aluminum wire conductor with the impression undergoes a larger stress than a cross-section of the aluminum wire conductor with no impression. Unfortunately, the aluminum wire conductor with the impression is more likely to break than the aluminum wire conductor with no impression.

As described above, the aluminum wire conductor is likely to break. In addition to the above issue, an increase in gripping force of the gripper causes the area of contact between the gripper and the surface of the insulating coating covering the aluminum wire conductor to be larger than the area of contact between the gripper and the surface of the insulating coating covering the copper wire conductor. Thus, the insulating coating covering the aluminum wire conductor is affected to a larger extent than the insulating coating covering the copper wire conductor by the gripping force of the gripper. Since the surfaces of the insulating coatings are in contact with the gripper and are affected by the gripping force of the gripper, the surfaces may suffer, for example, deformation or damage, causing an impression or cracking. It is difficult to guarantee the dielectric strength of the insulating coating covering the aluminum wire conductor.

Under the above-described conditions where the aluminum wire conductor is likely to break and it is difficult to guarantee the dielectric strength of the insulating coating covering the aluminum wire conductor, coils are likely to suffer a short-circuit and/or burning.

### SUMMARY

In response to the above issue, it is an object of the present disclosure to provide coils that are less likely to suffer a short-circuit and/or burning.

A stator according to an embodiment of the present disclosure includes a hollow cylindrical stator core, a first coated wire including a first wire conductor and an insulating coating covering the first wire conductor, and a second coated wire including a second wire conductor and an insulating coating covering the second wire conductor, the first and second wire conductors having different hardnesses, the first wire conductor being harder than the second wire conductor, the insulating coating covering the second wire conductor being thicker than the insulating coating covering the first wire conductor. The first coated wire and the second coated wire are wound together around teeth arranged in a circumferential direction of the stator core.

A motor according to another embodiment of the present disclosure includes a stator and a rotor configured to be rotated with a magnetic field generated by the stator, the stator including a hollow cylindrical stator core, a first coated wire including a first wire conductor and an insulating coating covering the first wire conductor, and a second coated wire including a second wire conductor and an insulating coating covering the second wire conductor, the first and second wire conductors having different hardnesses, the first wire conductor being harder than the second wire conductor, the insulating coating covering the second wire conductor being thicker than the insulating coating covering the first wire conductor, the first coated wire and the second coated wire being wound together around teeth arranged in a circumferential direction of the stator core.

A compressor according to still another embodiment of the present disclosure includes a motor including a stator and a rotor configured to be rotated with a magnetic field generated by the stator, a hermetically sealed container including a suction pipe through which a fluid is to be sucked and a discharge pipe through which the fluid is to be discharged, and a compression element configured to be driven by the motor to compress the fluid sucked through the suction pipe and discharge the compressed fluid through the discharge pipe, the stator including a hollow cylindrical stator core, a first coated wire including a first wire conductor and an insulating coating covering the first wire conductor, and a second coated wire including a second wire conductor and an insulating coating covering the second wire conductor, the first and second wire conductors having different hardnesses, the first wire conductor being harder than the second wire conductor, the insulating coating covering the second wire conductor being thicker than the insulating coating covering the first wire conductor, the first coated wire and the second coated wire being wound together around teeth arranged in a circumferential direction of the stator core.

A refrigeration cycle apparatus according to yet another embodiment of the present disclosure includes a compressor, a condenser configured to liquify a fluid, a pressure reducing device configured to reduce a pressure of the fluid compressed, and an evaporator configured to gasify the fluid, the compressor including a motor including a stator and a rotor configured to be rotated with a magnetic field generated by the stator, a hermetically sealed container including a suction pipe through which the fluid is to be sucked and a discharge pipe through which the fluid is to be discharged, and a compression element configured to be driven by the motor to compress the fluid sucked through the suction pipe and discharge the compressed fluid through the discharge pipe, the stator including a hollow cylindrical stator core, a first coated wire including a first wire conductor and an insulating coating covering the first wire conductor, and a second coated wire including a second wire conductor and an insulating coating covering the second wire conductor, the first and second wire conductors having different hardnesses, the first wire conductor being harder than the second wire conductor, the insulating coating covering the second wire conductor being thicker than the insulating coating covering the first wire conductor, the first coated wire and the second coated wire being wound together around teeth arranged in a circumferential direction of the stator core.

A stator manufacturing method according to still yet another embodiment of the present disclosure includes: producing a first coated wire and a second coated wire, the first coated wire including a first wire conductor and an insulating coating covering the first wire conductor, the second coated wire including a second wire conductor and an insulating coating covering the second wire conductor, the first and second wire conductors having different hardnesses, the first wire conductor being harder than the second wire conductor, the insulating coating covering the second wire conductor being thicker than the insulating coating covering the first wire conductor; and winding the first coated wire and the second coated wire together around teeth arranged in a circumferential direction of a hollow cylindrical stator core.

### Advantageous Effects of Invention

The embodiments of the present disclosure allow inhibition of a short-circuit in and/or burning of coils.

### BRIEF DESCRIPTION OF DRAWINGS

FIG. 1 is a diagram illustrating a refrigeration cycle apparatus according to Embodiment 1.

FIG. 2 is a diagram illustrating the refrigeration cycle apparatus according to Embodiment 1.

FIG. 3 is a longitudinal sectional view of a compressor in Embodiment 1.

FIG. 4 is a schematic diagram illustrating a stator in Embodiment 1.

FIG. 5 is a cross-sectional view of the stator in Embodiment 1.

FIG. 6 is a connection diagram of coils in the stator in Embodiment 1.

FIG. 7 is a cross-sectional view illustrating a cross-sectional structure of winding in Embodiment 1.

FIG. 8 is a flowchart illustrating a stator manufacturing method in Embodiment 1.

FIG. 9 is a schematic diagram illustrating a gripper in Embodiment 1.

FIG. 10 is a cross-sectional view illustrating a cross-sectional structure of related-art winding.

FIG. 11 is a cross-sectional view illustrating a cross-sectional structure of winding in Embodiment 2.

FIG. 12 is a cross-sectional view illustrating a cross-sectional structure of winding in Embodiment 3.

### DETAILED DESCRIPTION

Embodiments of the present disclosure will be described below with reference to the attached drawings. The figures are schematically drawn. The relationship between the sizes of components in different figures and the relationship between the positions of the components in the different figures are not necessarily precisely illustrated and may be changed as appropriate. In the following description, similar components are illustrated with the same reference signs, and their names and functions are the same or similar. A detailed description of these similar components may therefore be omitted.

### Embodiment 1

A refrigeration cycle apparatus 1 according to Embodiment 1 will be described. The refrigeration cycle apparatus 1 includes a compressor 2, a condenser 3, a pressure reducing device 4, an evaporator 5, a four-way valve 6, a refrigerant circuit 7, and a controller 8.

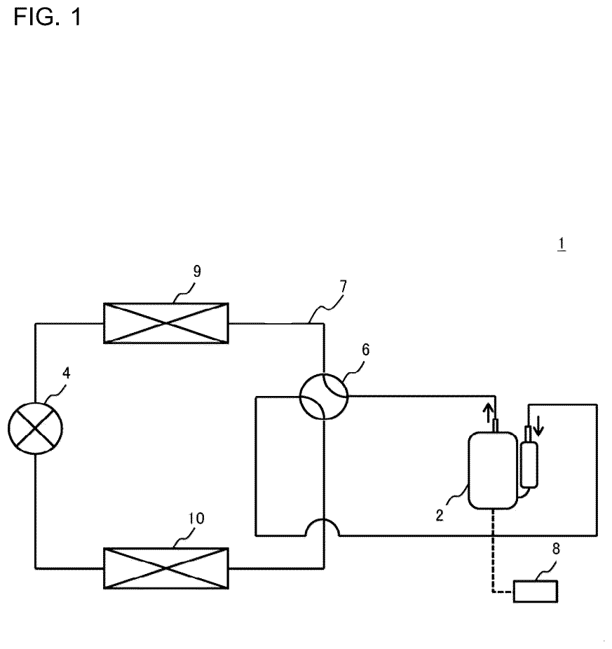

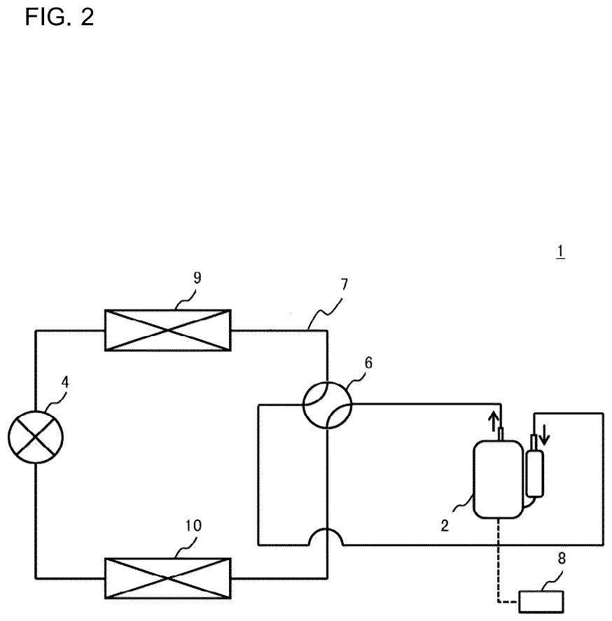

Assuming that the refrigeration cycle apparatus 1 is an air-conditioning apparatus, the configuration and action of the refrigeration cycle apparatus 1 will now be described with reference to FIGS. 1 and 2.

The compressor 2, the condenser 3, the pressure reducing device 4, the evaporator 5, and the four-way valve 6 are connected by refrigerant pipes, thus forming a refrigeration cycle in which refrigerant is circulated through the compressor 2, the four-way valve 6, the condenser 3, the pressure reducing device 4, and the evaporator 5 in that order.

The compressor 2 sucks the refrigerant from the refrigerant circuit 7, compresses the refrigerant into a high-temperature, high-pressure state, and discharges the compressed refrigerant to the four-way valve 6.

The four-way valve 6 switches a refrigerant flow between a heating operation and a cooling operation.

The condenser 3 exchanges heat with the refrigerant compressed by the compressor 2 and thus causes the compressed refrigerant to transfer heat, thereby liquifying the refrigerant.

The pressure reducing device 4 expands the refrigerant that has transferred heat in the condenser 3.

The evaporator 5 exchanges heat with the refrigerant expanded by the pressure reducing device 4 and thus heats the expanded refrigerant, thereby gasifying the refrigerant.

The controller 8 controls the whole of the refrigeration cycle apparatus 1 in response to an instruction from an input device, such as a remote control, thereby controlling the refrigerant flow. For example, the controller 8 controls the four-way valve 6 and the frequency of the compressor 2. The controller 8 includes an analog circuit, a digital circuit, a central processing unit (CPU), and a memory or includes a combination of two or more of them. The controller 8 may be disposed in the refrigeration cycle apparatus 1 or may be disposed in a different housing.

The refrigerant used is, for example, at least one refrigerant selected from the group consisting of a hydrofluorocarbon (HFC)-based refrigerant such as R32, R125, R134a, R407C, or R410A, a hydrofluoroolefin (HFO)-based refrigerant such as R1123, R1132(E), R1132(Z), R1132a, R1141, R1234yf, R1234ze(E), or R1234ze(Z), and a natural refrigerant such as R290 (propane), R600a (isobutene), R744 (carbon dioxide), or R717 (ammonia).

The action of the refrigeration cycle apparatus 1 will be described. Arrows illustrated in FIG. 1 represent a refrigerant flow direction in the cooling operation, and arrows illustrated in FIG. 2 represent the refrigerant flow direction in the heating operation. FIGS. 1 and 2 illustrate the four-way valve 6 with solid lines representing the refrigerant flow in the cooling operation or the heating operation.

The action of the refrigeration cycle apparatus 1 in the cooling operation will now be described.

The compressor 2 is driven, thereby discharging the compressed refrigerant from the compressor 2. The refrigerant discharged from the compressor 2 flows through the four-way valve 6 and enters a first heat exchanger 9, serving as the condenser 3. The first heat exchanger 9 exchanges heat with the refrigerant that has entered the first heat exchanger and thus causes the refrigerant to transfer heat. The refrigerant leaving the first heat exchanger 9 is expanded by the pressure reducing device 4. The refrigerant expanded by the pressure reducing device 4 enters a second heat exchanger 10, serving as the evaporator 5. The second heat exchanger 10 exchanges heat with the refrigerant that has entered the second heat exchanger and thus heats the refrigerant. The refrigerant leaving the second heat exchanger 10 flows through the four-way valve 6 and enters the compressor 2, where the refrigerant is compressed. The compressed refrigerant is discharged from the compressor 2 again. Such a cycle is repeated.

The action of the refrigeration cycle apparatus 1 in the heating operation will now be described.

The compressor 2 is driven, thereby discharging the compressed refrigerant from the compressor 2. The refrigerant discharged from the compressor 2 flows through the four-way valve 6 and enters the second heat exchanger 10, serving as the condenser 3. The second heat exchanger 10 exchanges heat with the refrigerant that has entered the second heat exchanger and thus causes the refrigerant to transfer heat. The refrigerant leaving the second heat exchanger 10 is expanded by the pressure reducing device 4. The refrigerant expanded by the pressure reducing device 4 enters the first heat exchanger 9, serving as the evaporator 5. The first heat exchanger 9 exchanges heat with the refrigerant that has entered the first heat exchanger and thus heats the refrigerant. The refrigerant leaving the first heat exchanger 9 flows through the four-way valve 6 and enters the compressor 2, where the refrigerant is compressed. The compressed refrigerant is discharged from the compressor 2 again. Such a cycle is repeated.

Although Embodiment 1 describes the example in which the refrigeration cycle apparatus 1 is an air-conditioning apparatus, the refrigeration cycle apparatus 1 may be a refrigeration cycle apparatus other than the air-conditioning apparatus. Examples of the refrigeration cycle apparatus 1 include a heat pump cycle apparatus.

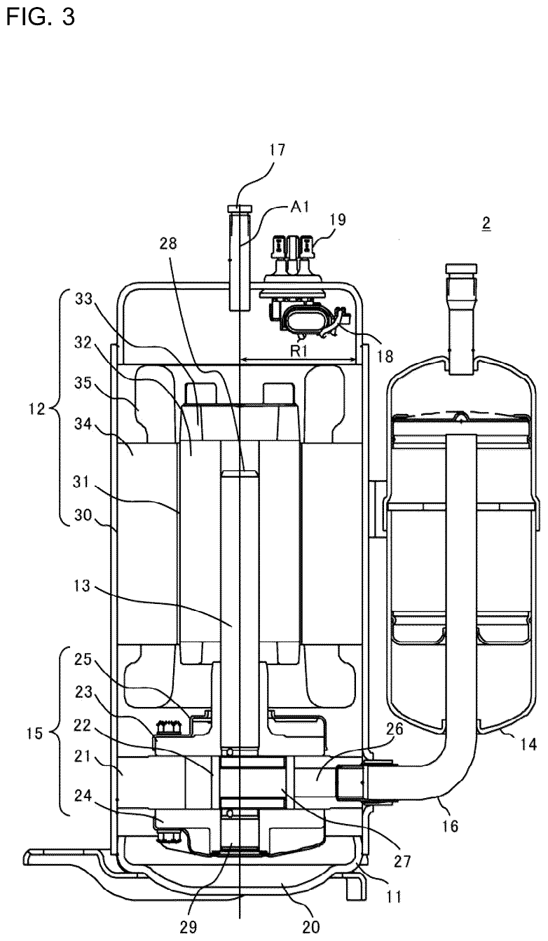

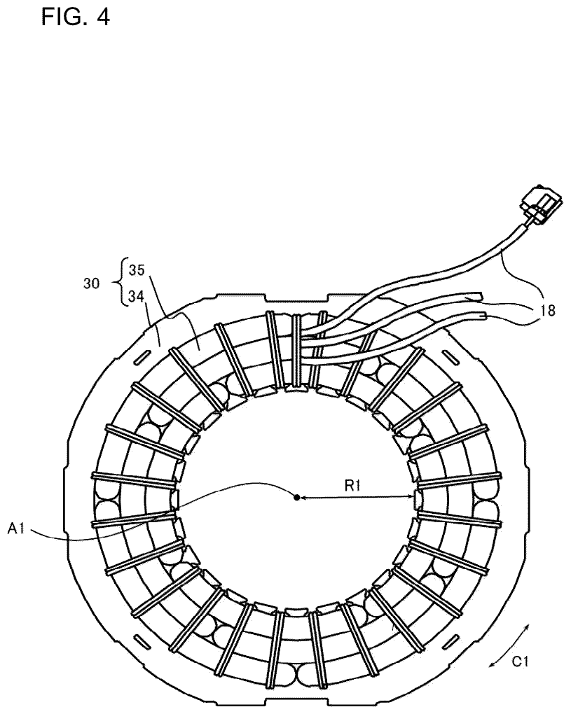

The compressor 2 in Embodiment 1 will now be described. The compressor 2 includes a hermetically sealed container 11, a motor 12, a crankshaft 13, a suction muffler 14, and a compression element 15. Assuming that the compressor 2 is a single-cylinder rotary compressor, the configuration of the compressor 2 will be described with reference to FIG. 3. In the following description, a direction along the axis, denoted by A1, of a stator 30 and a rotor 31 in FIGS. 3 and 4 will be referred to as an “axial direction”, a direction along the circumference, represented by arrows C1, centered on the axis will be referred to as a “circumferential direction”, and a direction along the radius, represented by arrows R1, centered on the axis will be referred to as a “radial direction”.

The hermetically sealed container 11 includes a suction pipe 16 to suck the refrigerant and a discharge pipe 17 to discharge the refrigerant. An upper portion of the hermetically sealed container 11 has a terminal 19 connecting an external power source and lead wires 18. A bottom portion of the hermetically sealed container 11 stores refrigerating machine oil 20 to lubricate sliding parts of the compression element 15. Examples of the refrigerating machine oil 20 include polyol ester (POE), polyvinyl ether (PVE), and alkylbenzene (AB).

The motor 12 is disposed above the compression element 15 inside the hermetically sealed container 11, and drives the compression element 15 through the crankshaft 13. The refrigerant compressed by the compression element 15 is discharged out of the hermetically sealed container 11 via the motor 12.

The suction muffler 14 is disposed outside the hermetically sealed container 11 and is connected to the suction pipe 16. The suction muffler 14 supplies the refrigerant from the refrigerant circuit 7 of the refrigeration cycle to a cylinder 21 through the suction pipe 16.

The compression element 15 includes the cylinder 21, a rolling piston 22, a vane (not illustrated), a main bearing 23, and a sub-bearing 24. The compression element 15 is disposed inside the hermetically sealed container 11. The rolling piston 22 is disposed in a cylinder chamber, which will be described later. The vane is disposed in the cylinder 21. The sub-bearing 24, the cylinder 21, and the main bearing 23 are arranged in that order from the bottom. Furthermore, the compression element 15 compresses the refrigerant sucked from the suction muffler 14 through the suction pipe 16 and discharges the compressed refrigerant from a discharge valve, which will be described later, via a discharge muffler 25, which will be described later, and the motor 12 through the discharge pipe 17.

The cylinder 21, which has a hollow cylindrical shape, includes the cylinder chamber in a hollow cylindrical portion. The cylinder 21 further includes a suction port 26, through which the refrigerant can be sucked, extending from an outer circumferential surface of the cylinder 21 into the cylinder chamber and a discharge port (not illustrated), through which the refrigerant can be discharged, formed by cutting an upper edge of the cylinder 21.

The rolling piston 22, which has a hollow cylindrical shape, is attached to and slidable on an eccentric shaft portion 27 of the crankshaft 13. In the cylinder chamber, the rolling piston 22 performs eccentric rotational motion with rotation of the crankshaft 13 rotated and driven by the motor 12, so that the refrigerant is sucked, compressed, and discharged.

The vane, which is a rectangular cuboid, is disposed in and slidable along a vane groove (not illustrated). The vane is pressed against the rolling piston 22 by a vane spring (not illustrated) located in a vane back-pressure chamber (not illustrated).

The vane groove is located in the cylinder 21 and extends radially to communicate with the cylinder chamber and further extends axially through the cylinder 21. The vane back-pressure chamber is a circular space and is located between the vane groove and the outer circumferential surface of the cylinder 21.

Upon activation of the compressor 2, the vane is pressed against the rolling piston 22 by the vane spring because of no difference in pressure between the inside of the hermetically sealed container 11 and the cylinder chamber. During operation of the compressor 2, a higher pressure in the hermetically sealed container 11 than that in the cylinder chamber produces a force that presses the vane against the rolling piston 22.

The main bearing 23 supports a main shaft portion 28 located above the eccentric shaft portion 27 of the crankshaft 13 such that the main shaft portion 28 is rotatable. The main bearing 23 closes, from above, the cylinder chamber, the vane groove, and the vane back-pressure chamber. The main bearing 23 includes the discharge valve (not illustrated).

The sub-bearing 24 supports a sub-shaft portion 29 located below the eccentric shaft portion 27 of the crankshaft 13 such that the sub-shaft portion 29 is rotatable. The sub-bearing 24 closes, from below, the cylinder chamber, the vane groove, and the vane back-pressure chamber.

The discharge muffler 25 is disposed outside the main bearing 23 and causes the refrigerant to be released from the cylinder chamber through the discharge valve into the hermetically sealed container 11.

Examples of materials for the cylinder 21, the main bearing 23, and the sub-bearing 24 include gray iron, sintered steel, and carbon steel. Examples of materials for the rolling piston 22 include alloy steel containing, for example, chromium. Examples of materials for the vane include high-speed steel.

Although Embodiment 1 describes the example in which the discharge valve is located in the main bearing 23 and the discharge muffler 25 is located outside the main bearing 23, the discharge valve and the discharge muffler 25 may be included in at least either the main bearing 23 or the sub-bearing 24.

The operation of the compressor 2 will now be described.

In response to power supplied from the terminal 19 to the motor 12 through the lead wires 18, the crankshaft 13 rotates, and the rolling piston 22 eccentrically rotates inside the cylinder 21. The inside of the cylinder chamber is divided into two spaces by the rolling piston 22 and the vane. The two spaces change in volume as the crankshaft 13 rotates. As the volume of one of the spaces gradually increases, the refrigerant is sucked into the space from the suction muffler 14 through the suction pipe 16 and the suction port 26. As the volume of the other space gradually decreases, the refrigerant in the space is compressed and discharged into the hermetically sealed container 11 from the space through the discharge valve and the discharge muffler 25. The refrigerant discharged inside the hermetically sealed container 11 is discharged out of the hermetically sealed container 11 via the motor 12 through the discharge pipe 17.

Although Embodiment 1 describes the example in which the compressor 2 is a single-cylinder rotary compressor, the compressor 2 may be any compressor 2 other than the single-cylinder rotary compressor. Examples of the compressor 2 include a multi-cylinder rotary compressor and a scroll compressor.

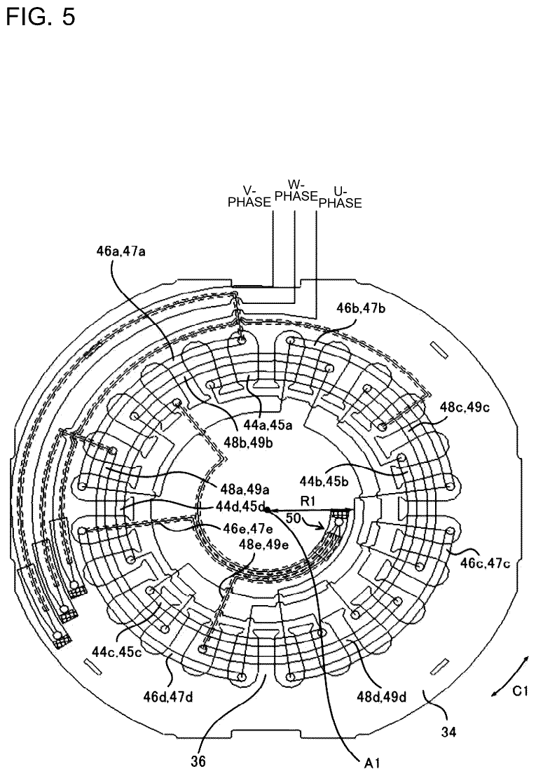

The motor 12 in Embodiment 1 will now be described. The motor 12 includes the stator 30 and the rotor 31, which is located at a predetermined gap from the stator 30 and has the same axis as that of the stator 30. In the motor 12, alternating current (AC) power supplied to coils 35 on the stator 30 produces a rotating magnetic field. The interaction between AC and the rotating magnetic field rotates the rotor 31. Assuming that the motor 12 is a squirrel-cage induction motor, the configuration of the motor 12 will now be described with reference to FIGS. 3 to 6.

In Embodiment 1, it is assumed that the rotor 31 is included in the squirrel-cage induction motor. The rotor 31 will be described.

As illustrated in FIG. 3, the rotor 31 includes a rotor core 32, rotor bars (not illustrated), and end rings 33.

The rotor core 32 is solid and cylindrical and has slots (not illustrated) arranged at regular intervals in the circumferential direction. The rotor core 32 is fabricated such that multiple electromagnetic steel plates stamped into a predetermined shape and each having a thickness of from 0.1 to 1.5 mm are stacked in the axial direction and are fastened by, for example, riveting or welding. The rotor core 32 has a through-hole (not illustrated) extending in the axial direction. The through-hole serves as a passage for gaseous refrigerant to be discharged from the discharge muffler 25 into the hermetically sealed container 11.

The rotor bars, serving as electric conductors, have a length in the axial direction, a width in the circumferential direction, and a thickness in the radial direction. The rotor bars fill or are disposed in the slots. The rotor bars are made of, for example, aluminum.

The end rings 33 short circuit opposite ends of the rotor bars.

Although Embodiment 1 describes the example in which the rotor 31 is the rotor 31 included in the squirrel-cage induction motor, the rotor 31 may be the rotor 31 included in the motor 12 other than the squirrel-cage induction motor. The rotor 31 is the rotor 31 included in, for example, a direct current (DC) motor, a brushless DC motor, or an AC motor.

As illustrated in FIGS. 4 to 6, the stator 30 includes a stator core 34 and the coils 35.

The stator core 34 is hollow and cylindrical and has teeth 36 arranged at regular intervals in the circumferential direction. The stator core 34 is fabricated such that multiple electromagnetic steel plates stamped into a predetermined shape and each having a thickness of from 0.1 to 1.5 mm are stacked in the axial direction and fastened by, for example, riveting or welding. The stator core 34 has an outer circumference with notches (not illustrated) arranged at regular intervals in the circumferential direction. The notches each serve as a passage for gaseous refrigerant to be discharged from the discharge muffler 25 into the hermetically sealed container 11 and the refrigerating machine oil 20 to be returned from the motor 12 to the bottom portion of the hermetically sealed container 11.

The coils 35 include a U-phase coil unit 41, a V-phase coil unit 42, and a W-phase coil unit 43, which are independent of each other. Furthermore, the coils are connected to the lead wires 18 for power supply from the power source to the motor 12.

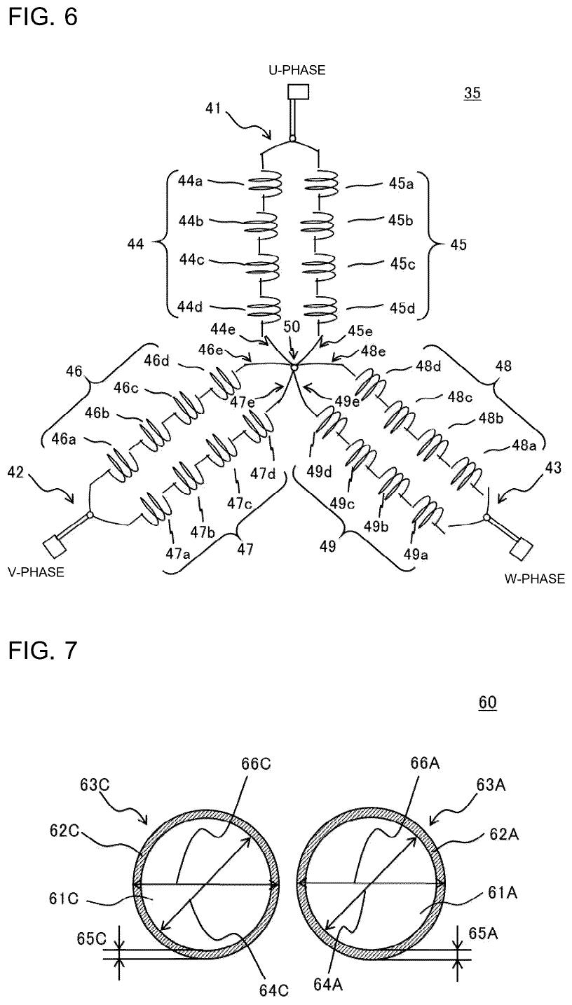

As illustrated in FIG. 6, the U-phase coil unit 41 includes a U-phase copper-wire coil group 44 and a U-phase aluminum-wire coil group 45, the V-phase coil unit 42 includes a V-phase copper-wire coil group 46 and a V-phase aluminum-wire coil group 47, and the W-phase coil unit 43 includes a W-phase copper-wire coil group 48 and a W-phase aluminum-wire coil group 49.

The U-phase copper-wire coil group 44 includes four U-phase copper-wire coils 44a, 44b, 44c, and 44d. The U-phase aluminum-wire coil group 45 includes four U-phase aluminum-wire coils 45a, 45b, 45c, and 45d. The V-phase copper-wire coil group 46 includes four V-phase copper-wire coils 46a, 46b, 46c, and 46d. The V-phase aluminum-wire coil group 47 includes four V-phase aluminum-wire coils 47a, 47b, 47c, and 47d. The W-phase copper-wire coil group 48 includes four W-phase copper-wire coils 48a, 48b, 48c, and 48d. The W-phase aluminum-wire coil group 49 includes four W-phase aluminum-wire coils 49a, 49b, 49c, and 49d.

A U-phase copper-wire end 44e as one of ends of the U-phase copper-wire coils 44a, 44b, 44c, and 44d and a U-phase aluminum-wire end 45e as one of ends of the U-phase aluminum-wire coils 45a, 45b, 45c, and 45d are connected to a neutral point 50. Similarly, a V-phase copper-wire end 46e as one of ends of the V-phase copper-wire coils 46a, 46b, 46c, and 46d and a V-phase aluminum-wire end 47e as one of ends of the V-phase aluminum-wire coils 47a, 47b, 47c, and 47d are connected to the neutral point 50. A W-phase copper-wire end 48e as one of ends of the W-phase copper-wire coils 48a, 48b, 48c, and 48d and a W-phase aluminum-wire end 49e as one of ends of the W-phase aluminum-wire coils 49a, 49b, 49c, and 49d are connected to the neutral point 50.

In the above-described configuration, the U-phase copper-wire coil group 44, the V-phase copper-wire coil group 46, the W-phase copper-wire coil group 48, the U-phase aluminum-wire coil group 45, the V-phase aluminum-wire coil group 47, and the W-phase aluminum-wire coil group 49 are concentrated at one place, thus forming the neutral point 50.

Winding 60 in Embodiment 1 will now be described. The winding 60 is a generic term for two coated wires, which will be described later, and is wound around the teeth 36 of the stator 30 to form the coils 35.

FIG. 7 illustrates a cross-sectional structure of the winding 60 in Embodiment 1. The winding 60 includes two coated wires. The coated wires include wire conductors having different hardnesses and insulating coatings covering the wire conductors having the different hardnesses. The wire conductors having the different hardnesses, or a soft wire conductor and a hard wire conductor, have the same wire diameter. An insulating coating covering the soft wire conductor has a larger thickness than an insulating coating covering the hard wire conductor. The winding 60 will be described in detail below.

The coated wires and the wire conductors each have a circular cross-sectional shape. The coated wires and the wire conductors each have a wire diameter defined by the diameter of a circle.

The wire conductor is made of copper or aluminum. The hardness of copper differs from that of aluminum. Copper has a Vickers hardness of from approximately 50 to approximately 60 HV. Aluminum has a Vickers hardness of from approximately 20 to approximately 30 HV. In other words, the hard wire conductor of the wire conductors having the different hardnesses is a copper wire conductor, and the soft wire conductor of the wire conductors having the different hardnesses is an aluminum wire conductor.

In the following description of the winding in Embodiment 1, the copper wire conductor will be referred to as a wire conductor 61C, the aluminum wire conductor will be referred to as a wire conductor 61A, an insulating coating covering the wire conductor 61C will be referred to as an insulating coating 62C, an insulating coating covering the wire conductor 61A will be referred to as an insulating coating 62A, a coated wire including the wire conductor 61C and the insulating coating 62C will be referred to as a coated wire 63C, and a coated wire including the wire conductor 61A and the insulating coating 62A will be referred to as a coated wire 63A.

A wire diameter 64C of the wire conductor 61C and a wire diameter 64A of the wire conductor 61A measure, for example, 1.0 mm. The insulating coating 62C has a thickness 65C of, for example, 0.04 mm. The insulating coating 62A has a thickness 65A of, for example, 0.052 mm. The insulating coating 62C and the insulating coating 62A are made of an electrical insulating material, such as polyamide-imide, polyester-imide, polyester, polyurethane, or polyvinyl formal. In this case, the coated wire 63C has a wire diameter 66C of 1.08 mm, which is the sum of the wire diameter 64C of the wire conductor 61C and two times the thickness 65C of the insulating coating 62C. Similarly, the coated wire 63A has a wire thickness 66A of 1.104 mm.

Although Embodiment 1 describes the example in which the coated wire 63C includes a thickness of 0.04 mm and the coated wire 63A includes a thickness of 0.052 mm, the coated wire 63C and the coated wire 63A may be selected based on the dimensions of wires specified in Japanese Industrial Standards (JIS) so that the wire diameter 64C of the wire conductor 61C is the same size as the wire diameter 64A of the wire conductor 61A and so that the thickness 65A of the insulating coating 62A is larger than the thickness 65C of the insulating coating 62C.

Although Embodiment 1 describes the example in which the coated wire 63C and the coated wire 63A are round wires, the coated wire 63C and the coated wire 63A may be flat rectangular wires.

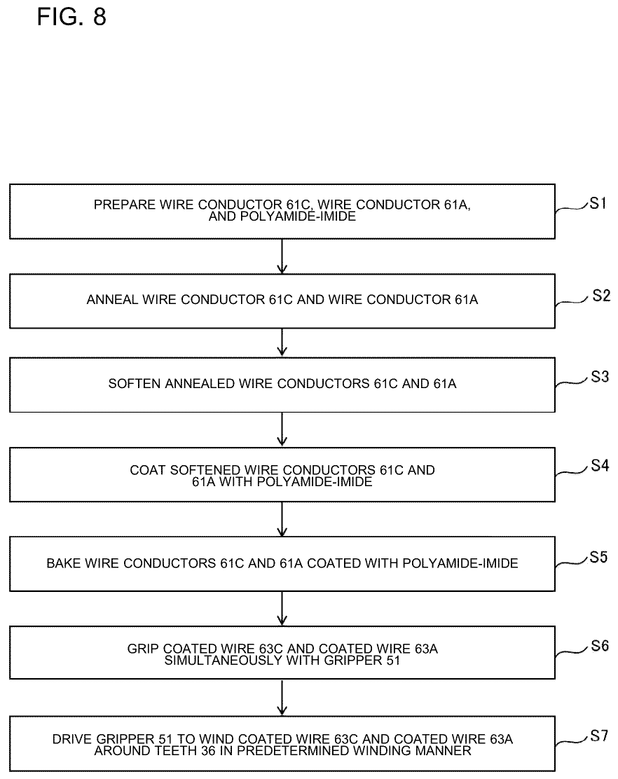

A method of manufacturing the stator 30 in Embodiment 1 will now be described with reference to FIG. 8.

In step S1, the wire conductor 61C, the wire conductor 61A, and an electrical insulating material are prepared. In the following description, it is assumed that the electrical insulating material is polyamide-imide.

In step S2, the wire conductor 61C and the wire conductor 61A are annealed.

In step S3, the wire conductors 61C and 61A annealed in step S2 are softened.

In step S4, the wire conductors 61C and 61A softened in step S3 are coated with polyamide-imide.

In step S5, the wire conductors 61C and 61A coated with polyamide-imide in step S4 are baked to form the insulating coating 62C and the insulating coating 62A, thereby forming the coated wire 63C and the coated wire 63A.

In this case, the wire diameter 64A of the wire conductor 61A and the wire diameter 64C of the wire conductor 61C are equal to each other, and the insulating coating 62C and the insulating coating 62A are formed such that the thickness 65A of the insulating coating 62A is larger than the thickness 65C of the insulating coating 62C.

In step S6, the coated wires 63C and 63A formed in step S5 are simultaneously gripped by using a gripper 51, which will be described later.

In step S7, the gripper 51 is driven to wind the coated wire 63C and the coated wire 63A around the teeth 36 in a predetermined winding manner. Examples of the winding manner include concentrated winding, concentric winding, lap winding, and wave winding.

Performing steps S1 to S7 completes the coils 35 in Embodiment 1. FIG. 4 illustrates the coils 35 formed by the coated wires 63C and 63A wound around the teeth 36 in a concentric winding manner.

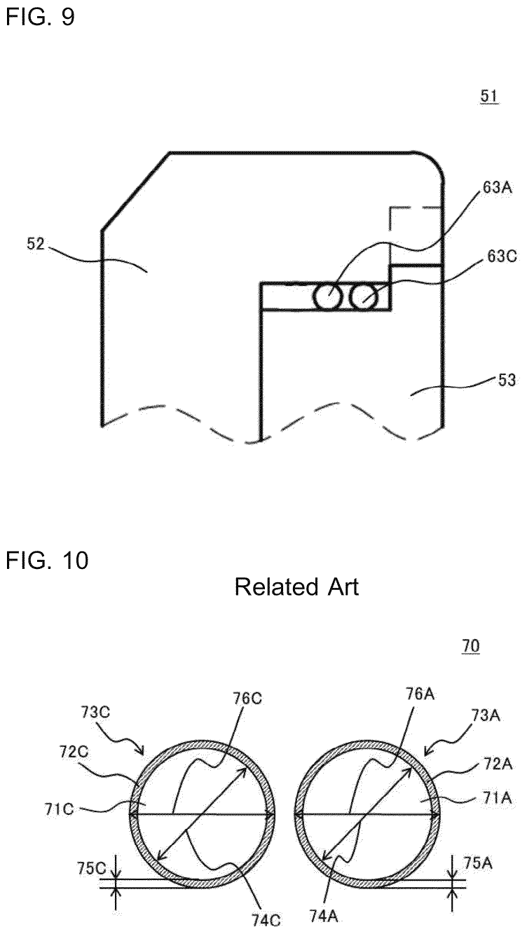

The gripper 51 will now be described. As illustrated in FIG. 9, the gripper 51 includes a fixed portion 52 and a movable portion 53. The gripper 51 is one of components of a winding machine that is a machine to produce the coils 35 from the winding 60. The winding machine drives the gripper 51 gripping the coated wire 63C and the coated wire 63A with the fixed portion 52 and the movable portion 53 to wind the coated wire 63C and the coated wire 63A around the teeth 36, thus producing the coils 35 from the coated wire 63C and the coated wire 63A.

Although Embodiment 1 describes the example in which the motor 12 is disposed inside the hermetically sealed container 11 of the compressor 2 and drives the compression element 15 incorporated in the compressor 2, the motor 12 may drive a machine other than the compression element 15 incorporated in the compressor 2.

FIG. 10 illustrates a cross-sectional structure of related-art winding 70 for comparison with Embodiment 1. The winding 70 includes two coated wires. The coated wires include wire conductors having different hardnesses and insulating coatings covering the wire conductors having the different hardnesses. The wire conductors having the different hardnesses, or a soft wire conductor and a hard wire conductor, have the same wire diameter. An insulating coating covering the soft wire conductor has the same thickness as that of an insulating coating covering the hard wire conductor. In other words, the related-art winding 70 differs from the winding 60 in Embodiment 1 in that the insulating coating covering the soft wire conductor has the same thickness as that of the insulating coating covering the hard wire conductor. The winding 70 will now be described in detail below.

In the following description of the related-art winding 70, a copper wire conductor will be referred to as a wire conductor 71C, an aluminum wire conductor will be referred to as a wire conductor 71A, an insulating coating covering the wire conductor 71C will be referred to as an insulating coating 72C, an insulating coating covering the wire conductor 71A will be referred to as an insulating coating 72A, a coated wire including the wire conductor 71C and the insulating coating 72C will be referred to as a coated wire 73C, and a coated wire including the wire conductor 71A and the insulating coating 72A will be referred to as a coated wire 73A. In addition, the coated wires and the wire conductors each have a circular cross-sectional shape. The coated wires and the wire conductors each have a wire diameter defined by the diameter of a circle.

A wire diameter 74C of the wire conductor 71C and a wire diameter 74A of the wire conductor 71A measure, for example, 1.0 mm. A thickness 75C of the insulating coating 72C and a thickness 75A of the insulating coating 72A measure, for example, 0.04 mm. In this case, the coated wire 73C has a wire diameter 76C of 1.08 mm, which is the sum of the wire diameter 74C of the wire conductor 71C and two times the thickness 75C of the insulating coating 72C. Similarly, the coated wire 73A has a wire diameter 76A of 1.08 mm.

For related-art coils formed by winding the coated wire 73C and the coated wire 73A together around the teeth 36, the coated wire 73C and the coated wire 73A, or two wires, are simultaneously gripped by the gripper 51. In general, the wire diameters 74C and 74A of the wire conductors 71C and 71A are equalized and the thicknesses of the insulating coatings covering the wire conductors are equalized to eliminate a gap between the gripper 51 and the coated wires 73C and 73A that is caused by the difference between the wire diameter 76C of the coated wire 73C and the wire diameter 76A of the coated wire 73A.

The difference in hardness between the wire conductors, however, causes the wire conductors to be deformed by different amounts upon application of a gripping force of the gripper 51. This causes the extent of contact between the gripper 51 and one coated wire to differ from that between the gripper 51 and the other coated wire. For this reason, the coated wires are likely to slip from the gripper 51, which may cause winding irregularities.

When the gripping force of the gripper 51 is increased to prevent winding irregularities, the gripping force of the gripper 51 produces an impression in the wire conductor 71A, which is softer than the wire conductor 71C. A cross-section of the wire conductor 71A with the impression undergoes a larger stress than a cross-section of the wire conductor 71A with no impression. The wire conductor 71A with the impression is more likely to break than the wire conductor 71A with no impression.

As described above, the wire conductor 71A is likely to break. In addition to the above issue, an increase in gripping force of the gripper 51 causes the area of contact between the gripper 51 of the gripper 51 and the surface of the insulating coating 72A to be larger than the area of contact between the gripper 51 and the surface of the insulating coating 72C. Thus, the insulating coating 72A is affected to a larger extent than the insulating coating 72C by the gripping force of the gripper 51. Since the surfaces of the insulating coatings are in contact with the gripper 51 and are affected by the gripping force of the gripper 51, the surfaces may suffer, for example, deformation or damage, causing an impression or cracking. It is difficult to guarantee the dielectric strength of the insulating coating 72A.

In the stator 30 in Embodiment 1, the thickness 65A of the insulating coating 62A is larger than the thickness 65C of the insulating coating 62C, resulting in the difference between the thickness 65A of the insulating coating 62A and the thickness 65C of the insulating coating 62C. Since the wire conductor 61A is softer than the wire conductor 61C, the wire conductor 61A is deformed by a larger amount than the wire conductor 61C when the coated wire 63C and the coated wire 63A are simultaneously gripped, causing the difference between the amount of deformation of the wire conductor 61C and that of the wire conductor 61A. The difference between the amounts of deformation is offset by the difference between the thicknesses, so that the extent of contact between the gripper 51 and one of the coated wires is less likely to differ from the extent of contact between the gripper 51 and the other coated wire than in the related art. Thus, the coated wires are less likely to slip from the gripper 51, thus reducing or eliminating the occurrence of winding irregularities. Since the coated wires are less likely to slip from the gripper 51, it is unnecessary to increase the gripping force of the gripper 51. This reduces or eliminates the occurrence of an impression in the wire conductor 61A caused by an increase in gripping force of the gripper 51. Thus, the wire conductor 61A is less likely to break. In addition, this reduces or eliminates the occurrence of an impression in or cracking of the insulating coatings covering the wire conductors caused by an increase in gripping force of the gripper 51, thus reducing or eliminating a decrease in dielectric strength.

The stator 30 in Embodiment 1 further has advantages when the gripping force of the gripper 51 is increased to prevent winding irregularities. When the gripping force of the gripper 51 is increased, the area of contact between the gripper 51 of the gripper 51 and the surface of the insulating coating 62A is larger than the area of contact between the gripper 51 of the gripper 51 and the surface of the insulating coating 62C, so that the insulating coating 62A is affected to a larger extent than the insulating coating 62C by the gripping force of the gripper 51. Since the surfaces of the insulating coatings are in contact with the gripper 51 of the gripper 51 and are affected by the gripping force of the gripper 51, the surfaces may suffer, for example, deformation or damage, causing an impression or cracking. This may cause a decrease in dielectric strength of the insulating coating 62A.

In this case, the insulating coating 62A is thicker by an amount corresponding to the difference between the thicknesses. This guarantees sufficient dielectric strength of the insulating coating 62A if the surface of the insulating coating 62A suffers, for example, deformation or damage that causes an impression or cracking, as compared with the related art. For the coils 35, as described above, the wire conductor 61A is less likely to break, and the insulating coating 62A is guaranteed to have sufficient dielectric strength. This inhibits a short-circuit in and/or burning of the coils 35.

The stator 30 in Embodiment 1 includes the hollow cylindrical stator core 34, a first coated wire including a first wire conductor and an insulating coating covering the first wire conductor, and a second coated wire including a second wire conductor and an insulating coating covering the second wire conductor, the first and second wire conductors having different hardnesses, the first wire conductor being harder than the second wire conductor, the insulating coating covering the second wire conductor being thicker than the insulating coating covering the first wire conductor. The first coated wire and the second coated wire are wound together around the teeth 36 arranged in the circumferential direction of the stator core 34. Such a configuration inhibits a short-circuit in and/or burning of the coils 35.

The motor 12 in Embodiment 1 includes the stator 30 and the rotor 31 configured to be rotated with a magnetic field generated by the stator 30, the stator 30 including the hollow cylindrical stator core 34, the first coated wire including the first wire conductor and the insulating coating covering the first wire conductor, and the second coated wire including the second wire conductor and the insulating coating covering the second wire conductor, the first and second wire conductors having the different hardnesses, the first wire conductor being harder than the second wire conductor, the insulating coating covering the second wire conductor being thicker than the insulating coating covering the first wire conductor, the first coated wire and the second coated wire being wound together around the teeth 36 arranged in the circumferential direction of the stator core 34. Such a configuration inhibits a short-circuit in and/or burning of the coils 35.

The compressor 2 in Embodiment 1 includes the motor 12, the hermetically sealed container 11 including the suction pipe 16 through which a fluid is to be sucked and the discharge pipe 17 through which the fluid is to be discharged, and the compression element 15 configured to be driven by the motor 12 to compress the fluid sucked through the suction pipe 16 and discharge the compressed fluid through the discharge pipe 17, the motor 12 including the stator 30 and the rotor 31 configured to be rotated with a magnetic field generated by the stator 30, the stator 30 including the hollow cylindrical stator core 34, the first coated wire including the first wire conductor and the insulating coating covering the first wire conductor, and the second coated wire including the second wire conductor and the insulating coating covering the second wire conductor, the first and second wire conductors having the different hardnesses, the first wire conductor being harder than the second wire conductor, the insulating coating covering the second wire conductor being thicker than the insulating coating covering the first wire conductor, the first coated wire and the second coated wire being wound together around the teeth 36 arranged in the circumferential direction of the stator core 34. Such a configuration inhibits a short-circuit in and/or burning of the coils 35.

The refrigeration cycle apparatus 1 in Embodiment 1 includes the compressor 2, the condenser 3 configured to liquify the fluid, the pressure reducing device 4 configured to reduce the pressure of the fluid compressed, and the evaporator 5 configured to gasify the fluid, the compressor 2 including the motor 12, the hermetically sealed container 11 including the suction pipe 16 through which the fluid is to be sucked and the discharge pipe 17 through which the fluid is to be discharged, and the compression element 15 configured to be driven by the motor 12 to compress the fluid sucked through the suction pipe 16 and discharge the compressed fluid through the discharge pipe 17, the motor 12 including the stator 30 and the rotor 31 configured to be rotated with a magnetic field generated by the stator 30, the stator 30 including the hollow cylindrical stator core 34, the first coated wire including the first wire conductor and the insulating coating covering the first wire conductor, and the second coated wire including the second wire conductor and the insulating coating covering the second wire conductor, the first and second wire conductors having the different hardnesses, the first wire conductor being harder than the second wire conductor, the insulating coating covering the second wire conductor being thicker than the insulating coating covering the first wire conductor, the first coated wire and the second coated wire being wound together around the teeth 36 arranged in the circumferential direction of the stator core 34. Such a configuration inhibits a short-circuit in and/or burning of the coils 35.

The method of manufacturing the stator 30 in Embodiment 1 includes: producing a first coated wire and a second coated wire, the first coated wire including a first wire conductor and an insulating coating covering the first wire conductor, the second coated wire including a second wire conductor and an insulating coating covering the second wire conductor, the first and second wire conductors having different hardnesses, the first wire conductor being harder than the second wire conductor, the insulating coating covering the second wire conductor being thicker than the insulating coating covering the first wire conductor; and winding the first coated wire and the second coated wire together around the teeth 36 arranged in the circumferential direction of the hollow cylindrical stator core 34. This method allows inhibition of a short-circuit in and/or burning of the coils 35.

### Embodiment 2

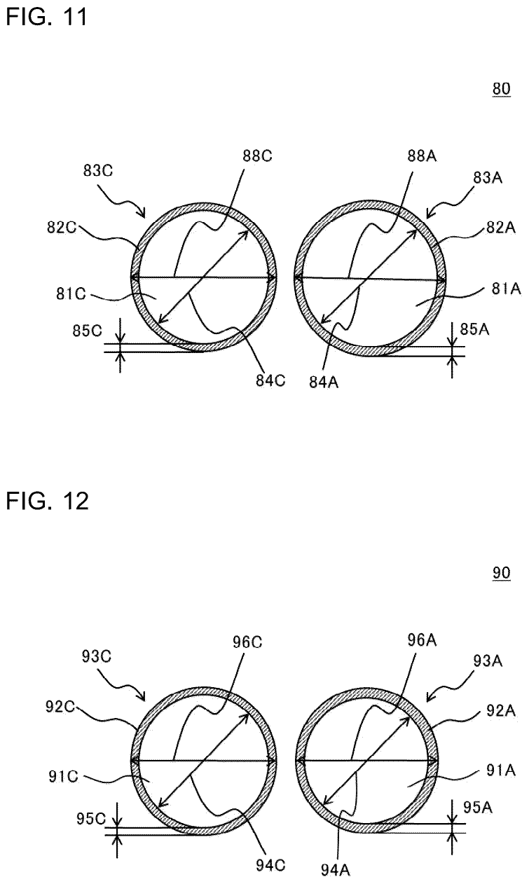

As illustrated in FIG. 11, winding 80 includes two coated wires. The coated wires include wire conductors having different hardnesses and insulating coatings covering the wire conductors having the different hardnesses. A soft wire conductor of the wire conductors having the different hardnesses has a larger wire diameter than a hard wire conductor. The insulating coating covering the soft wire conductor has a larger thickness than the insulating coating covering the hard wire conductor. In other words, the winding 80 in Embodiment 2 differs from the winding 60 in Embodiment 1 in that the wire diameter of the soft wire conductor of the wire conductors having the different hardnesses is larger than that of the hard wire conductor.

In the following description of the winding 80 in Embodiment 2, a copper wire conductor will be referred to as a wire conductor 81C, an aluminum wire conductor will be referred to as a wire conductor 81A, an insulating coating covering the wire conductor 81C will be referred to as an insulating coating 82C, an insulating coating covering the wire conductor 81A will be referred to as an insulating coating 82A, a coated wire including the wire conductor 81C and the insulating coating 82C will be referred to as a coated wire 83C, and a coated wire including the wire conductor 81A and the insulating coating 82A will be referred to as a coated wire 83A. In addition, the coated wires and the wire conductors each have a circular cross-sectional shape. The coated wires and the wire conductors each have a wire diameter defined by the diameter of a circle.

The wire conductor 81C has a wire diameter 84C of, for example, 1.0 mm. The wire conductor 81A has a wire diameter 84A of, for example, 1.05 mm. The insulating coating 82C has a thickness 85C of, for example, 0.04 mm. The insulating coating 82A has a thickness 85A of, for example, 0.052 mm. In this case, the coated wire 83C has a wire diameter 88C of 1.08 mm. Similarly, the coated wire 83A has a wire diameter 88A of 1.154 mm.

In addition to the advantages in Embodiment 1, a stator (not illustrated) in Embodiment 2 has the following advantages. If the gripping force of the gripper 51 is increased to prevent winding irregularities, the wire conductor 81A is less likely to break.

When the gripping force of the gripper 51 is increased to prevent winding irregularities, the gripping force of the gripper 51 produces an impression in the wire conductor 81A, which is softer than the wire conductor 81C. A cross-section of the wire conductor 81A with the impression undergoes a larger stress than a cross-section of the wire conductor 81A with no impression. Since the wire diameter 84A of the wire conductor 81A in Embodiment 2 is larger than the wire diameter 64A of the wire conductor 61A in Embodiment 1, the wire conductor 81A with the impression has a larger cross-sectional area. In other words, the cross-section of the wire conductor 81A undergoes a smaller stress than in Embodiment 1. Thus, the wire conductor 81A is less likely to break. For coils in Embodiment 2, as described above, the wire conductor 81A is less likely to break, and the insulating coating 82A is guaranteed to have sufficient dielectric strength. This inhibits a short-circuit in and/or burning of the coils in Embodiment 2.

### Embodiment 3

As illustrated in FIG. 12, winding 90 includes two coated wires. The coated wires include wire conductors having different hardnesses and insulating coatings covering the wire conductors having the different hardnesses. A soft wire conductor of the wire conductors having the different hardnesses has a smaller wire diameter than a hard wire conductor. The insulating coating covering the soft wire conductor has a larger thickness than the insulating coating covering the hard wire conductor. Furthermore, the two coated wires have the same wire diameter. In other words, the winding 90 in Embodiment 3 differs from the winding 60 in Embodiment 1 in that the two coated wires have the same wire diameter.

In the following description of the winding 90 in Embodiment 3, a copper wire conductor will be referred to as a wire conductor 91C, an aluminum wire conductor will be referred to as a wire conductor 91A, an insulating coating covering the wire conductor 91C will be referred to as an insulating coating 92C, an insulating coating covering the wire conductor 91A will be referred to as an insulating coating 92A, a coated wire including the wire conductor 91C and the insulating coating 92C will be referred to as a coated wire 93C, and a coated wire including the wire conductor 91A and the insulating coating 92A will be referred to as a coated wire 93A. In addition, the coated wires and the wire conductors each have a circular cross-sectional shape. The coated wires and the wire conductors each have a wire diameter defined by the diameter of a circle.

The wire conductor 91C has a wire diameter 94C of, for example, 1.0 mm. The wire conductor 91A has a wire diameter 94A of, for example, 0.976 mm. The insulating coating 92C has a thickness 95C of, for example, 0.04 mm. The insulating coating 92A has a thickness 95A of, for example, 0.052 mm. In this case, the coated wire 93C has a wire diameter 96C of 1.08 mm. Similarly, the coated wire 93A has a wire diameter 96A of 1.08 mm.

In a stator (not illustrated) in Embodiment 3, the thickness 95A of the insulating coating 92A is larger than the thickness 95C of the insulating coating 92C, resulting in the difference between the thickness 95A of the insulating coating 92A and the thickness 95C of the insulating coating 92C. When the gripping force of the gripper 51 is increased to prevent winding irregularities, the area of contact between the gripper 51 of the gripper 51 and the surface of the insulating coating 92A is larger than the area of contact between the gripper 51 of the gripper 51 and the surface of the insulating coating 92C, so that the insulating coating 92A is affected to a larger extent than the insulating coating 92C by the gripping force of the gripper 51. Since the surfaces of the insulating coatings are in contact with the gripper 51 of the gripper 51 and are affected by the gripping force of the gripper 51, the surfaces may suffer, for example, deformation or damage, causing an impression or cracking. This may cause a decrease in dielectric strength of the insulating coatings.

In this case, the insulating coating 92A is thicker by an amount corresponding to the difference between the thicknesses. This guarantees sufficient dielectric strength of the insulating coating 92A if the surface of the insulating coating 92A suffers, for example, deformation or damage that causes an impression or cracking, as compared with the related art. For coils in Embodiment 3, as described above, the insulating coating 92A is guaranteed to have sufficient dielectric strength. This inhibits a short-circuit in and/or burning of the coils in Embodiment 3.

Although the embodiments explained herein may describe, for example, the quality of material, material, dimensions, shape, relative arrangement relationship, or conditions of implementation of each component, these are examples in all aspects and the embodiments are not limited to those described herein. It is to be understood that countless modifications that are not illustrated are possible within the scope of the embodiments. Modifications include a case where any component is modified, added, or omitted, and further include a case where at least one component is extracted from at least one embodiment and is combined with a component in another embodiment.

1. A stator comprising:
a hollow cylindrical stator core;
a first coated wire including a first wire conductor and an insulating coating covering the first wire conductor; and
a second coated wire including a second wire conductor and an insulating coating covering the second wire conductor, the first and second wire conductors having different hardnesses, the first wire conductor being harder than the second wire conductor, the insulating coating covering the second wire conductor being thicker than the insulating coating covering the first wire conductor,
wherein the first coated wire and the second coated wire are wound together around a plurality of teeth arranged in a circumferential direction of the stator core.

2. The stator of claim 1, wherein the second wire conductor has a larger cross-sectional area than the first wire conductor.

3. The stator of claim 1, wherein the first coated wire and the second coated wire are equal in cross-sectional area.

4. The stator of claim 1, wherein the first wire conductor comprises copper, the second wire conductor comprises aluminum, and the insulating coating covering the first wire conductor and the insulating coating covering the second wire conductor comprise a material selected from the group consisting of polyamide-imide, polyester-imide, polyester, polyurethane, and polyvinyl formal.

5. The stator of claim 1, wherein the first coated wire and the second coated wire have a circular or rectangular cross-sectional shape.

6. A motor comprising:
the stator of claim 1, and
a rotor configured to be rotated with a magnetic field generated by the stator.

7. A compressor comprising:
the motor of claim 6;
a hermetically sealed container including a suction pipe through which a fluid is to be sucked and a discharge pipe through which the fluid is to be discharged; and
a compression element configured to be driven by the motor to compress the fluid sucked through the suction pipe and discharge the compressed fluid through the discharge pipe.

8. A refrigeration cycle apparatus comprising:
the compressor of claim 7;
a condenser configured to liquify the fluid;
a pressure reducing device configured to reduce a pressure of the compressed fluid; and
an evaporator configured to gasify the fluid.

9. A stator manufacturing method comprising:
producing a first coated wire and a second coated wire, the first coated wire including a first wire conductor and an insulating coating covering the first wire conductor, the second coated wire including a second wire conductor and an insulating coating covering the second wire conductor, the first and second wire conductors having different hardnesses, the first wire conductor being harder than the second wire conductor, the insulating coating covering the second wire conductor being thicker than the insulating coating covering the first wire conductor; and
winding the first coated wire and the second coated wire together around a plurality of teeth arranged in a circumferential direction of a hollow cylindrical stator core.

10. The compressor of claim 7, wherein
the fluid is a refrigerant, and
the refrigerant is, at least one refrigerant selected from the group consisting of a HFC-based refrigerant such as R32, R125, R134a, R407C, or R410A, a HFO-based refrigerant such as R1123, R1132(E), R1132(Z), R1132a, R1141, R1234yf, R1234ze(E), or R1234ze(Z), and a natural refrigerant such as R290, R600a, R744, or R717.
